(19) United States
(12) Patent Application Publication
(10) Pub. No.: US 2016/0345582 A1
(43) Pub. Date: Dec. 1, 2016

(54) HERBICIDE COMPOSITIONS FOR WEED CONTROL

(71) Applicant: Valent U.S.A., Corporation, Walnut Creek, CA (US)

(72) Inventor: Dawn E. Refsell, Lathrop, MO (US)

(21) Appl. No.: 15/164,995

(22) Filed: May 26, 2016

Related U.S. Application Data
(60) Provisional application No. 62/168,232, filed on May 29, 2015.

(51) Int. Cl. A01N 43/80; A01N 43/68; A01N 41/10; A01N 43/58; A01N 35/02

(52) U.S. Cl. CPC A01N 43/80; A01N 43/58; A01N 35/02; A01N 41/10; A01N 43/68

(57) ABSTRACT

The present invention is directed to compositions containing a pigment synthesis inhibitor herbicide selected from the group consisting of a pyridazinone, isoxazolidinone, triketone, and isoxazole, and pyroxasulfone in a ratio of pigment synthesis inhibitor herbicide to pyroxasulfone of from about 1:0.3 to about 1:150. The present invention is further directed to methods of increasing the activity of a pigment synthesis inhibitor herbicide with the compositions of the present invention.

### FIELD OF THE INVENTION

The present invention relates to agricultural compositions useful for controlling weeds, and methods of use thereof.

### BACKGROUND OF THE INVENTION

Unwanted plants, such as weeds, reduce the amount of resources available to crop plants and can have a negative effect on crop plant yield and quality. Unwanted plants in crop plant environments include broadleaves, grasses and sedges.

Herbicides are used to control weeds, in crop environments. Herbicides are expensive, and their use may result in unintentional consequences such as groundwater contamination, environmental damage, herbicide-resistant weeds, and/or human and mammalian health concerns. It is therefore desirable to minimize the amount of herbicides applied to a crop-growing environment or any area in need of weed control.

Weeds may greatly reduce yields of crop plants. For example, a horseweed infestation reportedly was responsible for an 80% reduction in soybean yields. Bruce, J. A., and J. J. Kells, Horseweed (Conyza Canadensis) control in no-tillage soybeans (Glycine max) with preplant and preemergence herbicides, Weed Technol. 4:642-647 (1990). Therefore, controlling weeds, and especially grasses and horseweed, is a major concern of crop growers.

Weeds also reduce the value of non-crop areas where their growth is aesthetically unpleasing such as roadsides, lawns, golf courses, or parks. In these areas the growth of weeds causes a perception that the owner or local government is disinterested in proper maintenance or is under-funded leading to drops in patronage or tourism. Reducing weeds in these areas by application of herbicides can be costly and resistance to these herbicides can lead to even more costly weed reducing measures.

Horseweed and grasses are becoming resistant to the widely used herbicide glyphosate. As early as 2000, glyphosate-resistant horseweed was reported in Delaware. Glyphosate-resistant horseweed has since been reported in numerous states. Accordingly, there is a need for new products that can provide effective kill rates of glyphosate-resistant horseweed.

Weeds are also becoming resistant to herbicides that inhibit acetolactate synthase (ALS) and protoporphyrinogen oxidase (PPO). Horseweed has also been reported to be resistant to 2,4-D and dicamba. Accordingly, there is a need for new technology to control weeds that are resistant to commercially available herbicides.

In most fields throughout the Midwest and Mid-South, in-crop burndown applications are the only options for controlling weeds due to weather and timeliness of applications. Growers often find an active ingredient that is effective and the use it repeatedly. Eventually, the weeds become resistant to the active ingredient which leaves no alternatives for weed control other than mechanical removal. Mechanical removal of weeds requires extensive use of resources and is not an option for no-till or highly erodible land.

No-till farming has been increasing in popularity because it has many benefits, including decreased labor time and decreased soil erosion. However, one of the downsides of no-till farming is that weeds are harder to control in these areas because they are not subjected to tilling. Accordingly, there is an increasing need for alternative ways to handle weed infestation.

Pyroxasulfone (3-[[[5-(difluoromethoxy)-1-methyl-3 (trifluoromethyl)-1H-pyrazol-4-yl]methyl]sulfonyl]-4,5-dihydro-5,5-dimethylisoxazole) is an herbicide that has residual weed control. Pyroxasulfone, however, is not very effective for post emergence weed control. Pyroxasulfone is commercially available in a mixture with flumioxazin (Fierce®, available from and a registered trademark of Valent U.S.A. Corporation).

Pigment synthesis inhibitors are a group of herbicides that work by inhibiting compounds that protect the plant from destruction of their chlorophyll. Pigment inhibitors include the following classes of compounds: pyridazinones, isoxazolidinones, triketones, and isoxazoles.

Pyridazinones' primary site of action is phytoene synthase. Sandmann, et al., The inhibitory mode of action of the pyridazinone herbicide norflurazon on a cell-free carotenogenic enzyme system, Pesticide Biochemistry and Physiology, 14(2): October 1980, 185-191. Examples of pyridazinones include brompyrazon, chloridazon, dimidazon, flufenpyr, metflurazon, norflurazon, oxapyrazon, and pydanon.

Isoxazolidinones are herbicides that inhibit the biosynthesis of carotenoids. Carotenoids can function as protectors of chlorophyll. Isoxazolidinones block the synthesis of carotenoids early in the pathway, at the level of isopentylpyrophosphate. An example of an isoxazolidinone is clomazone.

Triketones are 4-hydroxyphenylpyruvate dioxygenase inhibitors which work by blocking an enzyme in the plants that breaks down tyrosine into components necessary for biosynthesis of certain molecules. Examples of triketones include mesotrione, tembotrione, topramezone, and fenquinotrione.

Isoxazoles are another group of herbicides that block the production of carotenoids. Isoxazoles inhibit the enzyme p-hydroxyphenylpyruvate dioxygenase which is necessary for the carotenoids' biosynthesis pathway to begin. Examples of isoxazoles include isoxaflutole and isoxachlortole.

WO2009/115434 generally discloses pyroxasulfone in a mixture with inhibitors of lipid biosynthesis, inhibitors of the photosystem or bleacher herbicides. This publication teaches that the ratio of pyroxasulfone to bleacher herbicides is from 250:1 to 1:250. This publication does not teach or suggest narrower ratios that would produce acceptable results. The publication also fails to provide any examples of pyroxasulfone plus bleacher herbicide mixtures and indicates that “[u]nfortunately, it is usually not possible to predict synergistic activity for combinations of known herbicides, even if the compounds show a close structural similarity to known synergistic combinations.” WO2009/115434, Background of the Invention. Accordingly, this publication fails to suggest enhanced activity of pigment synthesis inhibitors when applied with pyroxasulfone.

In summary, there is a need for a composition that reduces the amount of herbicides necessary to obtain sufficient weed control. Further these compositions should minimize the harm to crop plants. As more weeds become resistant to herbicides, alternative compositions with high weed control are desired. Further, as no-till farming continues to increase in popularity, there is a greater need for effective herbicides. A composition with effective weed control and lower dosage rate will save resources and also lead to increased crop plant yields, and decreased environmental, human, and mammalian health concerns.

### SUMMARY OF THE INVENTION

In one aspect, the present invention is directed to agricultural compositions comprising a pigment synthesis inhibitor herbicide selected from the group consisting of a pyridazinone, isoxazolidinone, triketone, and isoxazole, or an agriculturally acceptable salt thereof, and pyroxasulfone in a ratio of from about 1:0.3 to about 1:150.

In another aspect, the present invention is directed to methods for increasing the activity of a pigment synthesis inhibitor herbicide, or an agriculturally acceptable salt thereof, comprising applying the agricultural compositions of the present invention to an area in need of weed control.

### DETAILED DESCRIPTION OF THE INVENTION

It was unexpectedly discovered that pyroxasulfone significantly increases the burndown activity of pigment synthesis inhibitor herbicides compared to the activity of pigment synthesis inhibitor herbicides alone when the pyroxasulfone and pigment synthesis inhibitors are applied to weeds at amounts within specific ratios. This finding was unexpected because pyroxasulfone applied alone is not satisfactory for post emergent weed control and generally has no postemergence activity. The present pigment inhibitor herbicide:pyroxasulfone ratios of the present invention have a greater speed of activity as well as an increased efficacy. Further, the present pigment inhibitor herbicide:pyroxasulfone ratios of the present invention are not phytotoxic to crop plants.

Compositions of the present invention containing the pigment inhibitor herbicide:pyroxasulfone ratios wherein the pigment inhibitor herbicide is selected from the group consisting of a pyridazinone, isoxazolidinone, triketone, and isoxazole, or an agriculturally acceptable salt thereof, will provide the end user with consistent herbicidal activity. The compositions will also provide residual weed and grass control.

In one embodiment, the present invention is directed to agricultural compositions comprising a pigment inhibitor herbicide selected from the group consisting of a pyridazinone, isoxazolidinone, triketone, and isoxazole, or an agriculturally acceptable salt thereof, and pyroxasulfone in a ratio of from about 1:0.3 to about 1:150. In a preferred embodiment, the compositions contain from about 1:0.6 to about 1:110 of pigment synthesis inhibitor:pyroxasulfone. In a more preferred embodiment, the compositions contain from about 1:0.7 to about 1:20 of pigment synthesis inhibitor:pyroxasulfone. In a most preferred embodiment, the compositions contain from about 1:0.8 to about 1:9.5 of pigment synthesis inhibitor:pyroxasulfone.

In an embodiment, the pyridazirone is selected from the group consisting of brompyrazon, chloridazon, dimidazon, flufenpyr, metflurazon, norflurazon, oxapyrazon, pydanon. In a preferred embodiment, the pyridazinone is norflurazon (4-chloro-5-methylamino-2-(α,α,α-trifluoro-m-tolyl)pyridazin-3(2H)-one). Norflurazon is commercially available as Zorial Rapid 80® (Zorial Rapid 80 is a registered trademark of and available from Syngenta Crop Protection, Inc.).

In another embodiment, the isoxazolidinone is selected from the group consisting of clomazone (2-[(2-chlorophenyl)methyl]-4,4-dimethyl-3-isoxazolidinone). Clomazone is commercially available as Command® 3ME (Command is available from and a registered trademark of FMC Corporation).

In a further embodiment, the triketone is selected from the group consisting of mesotrione (2[4-(methylsulfonyl)-2-nitrobenzoyl]cyclohexane-1,3-dione), tembotrione (2-[2-chloro-4-(methylsulfonyl)-3[(2,2,2-(trifluoroethoxy)methyl]benzoyl]-1,3-cyclohexanedione, topramezone [3-(4,5-dihydro-1,2-oxazol-3-yl)-4-mesyl-o-tolyl](5-hydroxy-1-methylpyrazol-4-yl)methanone and fenquinotrione (2-(8-chloro-3,4-dihydro-4-(4-methoxyphenyl)-3-oxoquinoxalin-2-ylcarbonyl)cyclohexane-1,3-dione). Mesotrione is commercially available as Callisto® (Callisto is a registered trademark of and available from Syngenta Crop Protection, Inc.). Tembotrione is commercially available as Laudis® (Landis is available from and a registered trademark of Bayer CropSciences). Topramezone is commercially available as Impact® (Impact is available from and a registered trademark of Amvac Chemical Corporation). Fenquinotrione is available from Kumiai Chemicals.

In yet another embodiment, the isoxazole is selected from the group consisting of isoxaflutole and isoxachlortole. In a preferred embodiment, the isoxazole is isoxaflutole. Isoxazole is commercially available as Balance® (Balance is available from and a registered trademark of Bayer CropSciences).

In an embodiment, the present invention is directed to methods for increasing the activity of a pigment synthesis inhibitor comprising applying agricultural compositions comprising a pigment synthesis inhibitor herbicide selected from the group consisting of a pyridazinone, isoxazolidinone, triketone, and isoxazole, or an agriculturally acceptable salt thereof, and pyroxasulfone in a ratio of from about 1:0.3 to about 1:150. In a preferred embodiment, the compositions contain from about 1:0.6 to about 1:110 of pigment synthesis inhibitor:pyroxasulfone. In a more preferred embodiment, the compositions contain from about 1:0.7 to about 1:20 of pigment synthesis inhibitor:pyroxasulfone. In a most preferred embodiment, the compositions contain from about 1:0,8 to about 1:9.5 of pigment synthesis inhibitor:pyroxasulfone.

In an embodiment, from about 50 to about 150 grams per hectare of pyroxasulfone is applied to the area in need of weed control. In a preferred embodiment, from about 70 to about 110 grams per hectare of pyroxasulfone is applied to the area in need of weed control. In a more preferred embodiment, from about 80 to about 100 grams per hectare of pyroxasulfone is applied to the area in need of weed control. In a most preferred embodiment, from about 85 to about 95 grams per hectare of pyroxasulfone is applied to the area in need of weed control.

In an embodiment, from about 1 to about 150 grams per hectare of pigment synthesis inhibitor is applied to the area in need of weed control. In a preferred embodiment, from about 1 to about 120 grams per hectare of pigment synthesis inhibitor is applied to the area in need of weed control. In a more preferred embodiment, from about 5 to about 115 grams per hectare of pigment synthesis inhibitor is applied to the area in need of weed control. In a most preferred embodiment, from about 10 to about 110 grams per hectare of pigment synthesis inhibitor is applied to the area in need of weed control.

In an embodiment, from about 50 to about 150 grams per hectare of mesotrione, or an agriculturally acceptable salt thereof, is applied to the area in need of weed control, in a preferred embodiment, from about 80 to about 120 grams per hectare of mesotrione, or an agriculturally acceptable salt thereof, is applied to the area in need of weed control. In a more preferred embodiment, from about 95 to about 115 grams per hectare of mesotrione, or an agriculturally acceptable salt thereof, is applied to the area in need of weed control. In a most preferred embodiment, from about 100 to about 110 grams per hectare of mesotrione, or an agriculturally acceptable salt thereof, is applied to the area in need of weed control.

In an embodiment, from about 1 to about 100 grams per hectare of topramezone, or an agriculturally acceptable salt thereof, is applied to the area in need of weed control. In a preferred embodiment, from about 1 to about 50 grams per hectare of topramezone, or an agriculturally acceptable salt thereof, is applied to the area in need of weed control. In a more preferred embodiment, from about 5 to about 30 grams per hectare of topramezone, or an agriculturally acceptable salt thereof, is applied to the area in need of weed control. In a most preferred embodiment, from about 10 to about 20 grams per hectare of topramezone, or an agriculturally acceptable salt thereof, is applied to the area in need of weed control.

In one embodiment, the present invention is directed to agricultural compositions comprising mesotrione, or an agriculturally acceptable salt thereof, and pyroxasulfone in a ratio of from about 1:0.3 to about 1:3. In a preferred embodiment, the compositions contain from about 1:0.5 to about 1:1.4 of mesotrione:pyroxasulfone. In a more preferred embodiment, the compositions contain from about 1:0.6 to about 1:0.9 of mesotrione:pyroxasulfone. In a most preferred embodiment, the compositions contain from about 1:0,7 to about 1:1 of mesotrione:pyroxasulfone.

In another embodiment, the present invention is directed to agricultural compositions comprising topramezone, or an agriculturally acceptable salt thereof, and pyroxasulfone in a ratio of from about 1:0.5 to about 1:150. In a preferred embodiment, the compositions contain from about 1:1.4 to about 1:110 of topramezone:pyroxasulfone. In a more preferred embodiment, the compositions contain from about 1:2.7 to about 1:20 of topramezone:pyroxasulfone. In a most preferred embodiment, the compositions contain from about 1:4.3 to about 1:9.5 of topramezone:pyroxasulfone.

In a further embodiment, the weed controlled by the compositions of the present invention is at least one of Waterhemp (Amaranthus tuberculatus), Horseweed (Conyza Canadensis), Ivyleaf Morningglory (Ipomoea hederacea), Pitted Morningglory (Ipomoea lacunose), Common Ragweed (Ambrosia artemisiifolia), Giant Ragweed (Ambrosia trifida), Large Crabgrass (Digitaria sanguinalis), Palmer Amaranth (Amaranthus palmeri), Broadleaf Signalgrass (Brachiaria platyhylla), Common Barnyardgrass (Echinochloa crus-galli), Yellow Nutsedge (Cyperus esculentus), Eclipta (Eclipta prostrate), Lambsquarters (Chenopodium species), Velvetleaf (Abutilon theophrasti), Foxtail (Setaria species), Giant Foxtail (Setaria faberi) and annual grasses. As used herein, annual grasses include corn, sorghums, wheat, rye, barley, and oats. In a preferred embodiment, the weed controlled is Waterhemp. In another preferred embodiment, the weed controlled is Common Ragweed. In yet another embodiment, the weed controlled is Ivyleaf Morningglory. In yet another embodiment, the weed controlled is Velvetleaf. in a further embodiment, the weed controlled is Giant Foxtail. In another embodiment, the weed controlled is Yellow Nutsedge.

In an embodiment of the invention, the pyroxasulfone and pigment synthesis inhibitor herbicide, or an agriculturally acceptable salt thereof, are applied concurrently to the area in need of weed control. In another embodiment, the pyroxasulfone and pigment synthesis inhibitor herbicide, or an agriculturally acceptable salt thereof, are applied sequentially to the area in need of weed control.

The herbicide mixtures of the present invention can be applied by any convenient means. Those skilled in the art are familiar with the modes of application that include foliar applications such as spraying, chemigation (a process of applying the mixture through the irrigation system), by granular application, or by impregnating the mixture on fertilizer.

The herbicide mixtures of the present invention can be prepared as concentrate formulations or as ready-to-use formulations. The mixtures can be tank mixed,

The herbicide mixtures of the present invention can be formulated to contain adjuvants, such as solvents, anti-caking agents, stabilizers, defoamers, slip agents, humectants, dispersants, wetting agents, thickening agents, emulsifiers, and preservatives which increase the long lasting activity of the actives. Other components that enhance the biological activity of these ingredients may optionally be included.

The herbicide mixtures of the present invention can be formulated to contain a liquid solvent. Examples of solvents include water or oil concentrates.

The herbicide mixtures of the present invention can also include one or more additional herbicides.

The mixtures of the present invention can be applied to any environment in need of weed control. The environment in need of weed control may include any area that is desired to have a reduced number of weeds or to be free of weeds including where crops are grown, and non-crop areas such as roadsides, lawns, golf courses and parks. Areas where crops are grown, for example, include, but are not limited to fields, orchards, and vineyards. For example, Applicants' compositions and methods can be applied to areas where soybeans, corn, peanuts, and cotton are growing. In a preferred embodiment, the mixture is applied in an area where a broadleaf crop (soybean, cotton, peanut, orchard, vineyard, forages) or corn is growing.

Applicants' compositions and methods can be applied successfully to crop plants and weeds that are resistant to glyphosate, glufosinate, or other herbicides. The composition and methods can also be applied to areas where genetically modified crops (“GMOs”) or non-GMO crops are growing. The term “GMO crops” as used herein refers to crops that are genetically modified.

Throughout the application, the singular forms “a,” “an,” and “the” include plural reference unless the context clearly dictates otherwise.

As used herein, “g ai/ha” is an abbreviation for grams of active ingredient per hectare.

As used herein, all numerical values relating to amounts, weight percentages and the like are defined as “about” or “approximately” each particular value, plus or minus 10%. For example, the phrase “at least 5.0% by weight” is to be understood as “at least 4.5% to 5.5% by weight.” Therefore, amounts within 10% of the claimed values are encompassed by the scope of the claims.

As used herein, “post emergence” refers to an herbicide treatment that is applied to an area after the weeds have germinated and emerged from the ground or growing medium.

As used herein, “burndown” refers to when an herbicide is used to reduce weed presence at the time of treatment. Burndown is often used in minimum or no-till fields because the weeds cannot be managed by tilling the soil. The burndown application may be used post-harvest and/or prior to crop emergence. Burndown is especially useful against weeds that emerge between growing seasons.

Applicant has referred to corn developmental stages in the following examples as “V” stages. The “V” stages are designated numerically as V1, V2, V3, etc. In this identification system of V(n), (n) represents the number of leaves with visible collars. Each leaf stage is defined according to the uppermost leaf whose leaf collar is visible.

These representative embodiments are in no way limiting and are described solely to illustrate some aspects of the invention.

Further, the following examples are offered by way of illustration only and not by way of limitation.

### EXAMPLES

### Example 1

In 2011, two field tests were conducted using similar protocols. Both studies were completed in Indiana, United States. Weeds were 4 to 10 inches in height at time of application. Untreated checks were included in the trial, however pyroxasulfone alone is not effective for post emergence weed control and was therefore not included as a standalone treatment. Roundup Ready corn (Zea maize) was used in the test as the crop plant utilizing a natural population of weeds. All of the treatments contained non-ionic surfactant at 0.25% v/v and were applied at the V5 corn growth stage. Applications were made utilizing a hand boom sprayer with application area for each treatment equating to 10 feet by 200 feet.

Topramezone was administered at 18.4 grams/hectare. Pyroxasulfone was administered at 90 grams/hectare.

Thirty days after treatment (“DAT”) readings were taken to determine the survival of Ivyleaf Morningglory, Yellow Nutsedge, Velvetleaf and Annual Grass. Survival ratings were taken by counting the number of alive and dead plants at the time of the reading. All data was analyzed using Bartlett's test and with p value of 0.5 for determining significance of the results. The results of this study can be seen below in “Table 1. The Effect of Topamezone and Pyroxasulfone on Weeds (% Control).”

TABLE 1
The Effect of Topramezone and Pyroxasulfone
on Weeds (% Control)

| | | Rate | | | | |
|---|---|---|---|---|---|---|
| | | (grams of | Ivyleaf | Yellow | | |
| | | ai per | Morn- | Nut- | Vel- | Annual |
| Study | Herbicide | hectare) | ingglory | sedge | vetleaf | Grass |
| 1 | Topramezone | 18.4 | 68 | 73 | — | — |
| | Topramezone | 18.4 | 85 | 80 | — | — |
| | Pyroxasulfone | 90 | | | | |
| 2 | Topramezone | 18.4 | — | — | 95 | 33 |
| | Topramezone | 18.4 | — | — | 99 | 42 |
| | Pyroxasulfone | 90 | | | | |

The results illustrate that a treatment of topramezone and pyroxasulfone is more effective than topramezone alone.

### Example 2

In 2013, seven field tests were conducted using similar protocols. The studies were completed in the following parts of the United States: Illinois, Indiana, Minnesota, Mississippi, Nebraska, and Iowa. Weeds were 4 to 10 inches in height at time of application. Untreated checks were included in the trial, however pyroxasulfone alone is not effective for post emergence weed control and was therefore not included as a standalone treatment. Roundup Ready corn (Zea maize) was used in the test as the crop plant utilizing a natural population of weeds. All of the treatments contained non-ionic surfactant at 0.25% v/v and were applied at the V5 corn growth stage. Applications were made utilizing a hand boom sprayer with application area for each treatment equating to 10 feet by 200 feet.

Topramezone was administered at 18.4 grams ai/hectare. Mesotrione was administered at 105 grams ai/hectare. Pyroxasulfone was administered at 90 grams/hectare. Atrazine, a triazine herbicide, was administered at 840 grams a.i./hectare.

Thirty days after treatment (“DAT”) readings were taken to determine the survival of Fall Panicum, Waterhemp, Common Ragweed, Giant foxtail, Foxtail, Palmer Amaranth, Giant Ragweed, Broadleaf signalgrass, Yellow Nutsedge, Barnyardgrass, and Velvetleaf. Survival ratings were taken by counting the number of alive and dead plants at the time of the reading. All data was analyzed using Bartlett's test and with p value of 0.5 for determining significance of the results. The results of this study can be seen below in “Table 2. The Effect of Topramezone, Mesotrione and Pyroxasulfone on Weeds (% Control).”

TABLE 2
The Effect of Topramezone, Mesotrione and Pyroxasulfone on Weeds (% Control)

| | | Rate | | | | | | | | | | | |
|---|---|---|---|---|---|---|---|---|---|---|---|---|---|
| | | (grams of | | | | | | Palmer | | Yellow | | Broadleaf | |
| | | ai per | Fall | Wa- | Common | Giant | Fox- | Ama- | Giant | Nut- | Barn- | sig- | Vel- |
| Study | Herbicide | hectare) | Panicum | terhemp | Ragweed | Foxtail | tail | ranth | Ragweed | sedge | yardgrass | nalgrass | vetleaf |
| 3 | Mesotrione | 105 | 98 | 80 | — | — | — | — | — | — | — | — | — |
| | Mesotrione | 105 | 100 | 85 | — | — | — | — | — | — | — | — | — |
| | Pyroxasulfone | 90 | | | | | | | | | | | |
| 4 | Topramezone | 18.4 | — | — | 94 | — | — | — | — | — | — | — | — |
| | Topramezone | 18.4 | — | — | 99 | — | — | — | — | — | — | — | — |
| | Pyroxasulfone | 90 | | | | | | | | | | | |
| 5 | Topramezone | 18.4 | — | — | — | 87 | — | — | — | — | — | — | — |
| | Topramezone | 18.4 | — | — | — | 95 | — | — | — | — | — | — | — |
| | Atrazine | 840 | | | | | | | | | | | |
| | Topramezone | 18.4 | — | — | — | 100 | — | — | — | — | — | — | — |
| | Pyroxasulfone | 90 | | | | | | | | | | | |
| | Topramezone | 18.4 | — | — | — | 100 | — | — | — | — | — | — | — |
| | Pyroxasulfone | 90 | | | | | | | | | | | |
| | Atrazine | 840 | | | | | | | | | | | |
| 6 | Topramezone | 18.4 | — | 94 | — | — | 98 | — | — | — | — | — | — |
| | Topramezone | 18.4 | — | 99 | — | — | 100 | — | — | — | — | — | — |
| | Pyroxasulfone | 90 | | | | | | | | | | | |
| 7 | Topramezone | 18.4 | — | — | — | — | — | 93 | 91 | 60 | 80 | 90 | — |
| | Topramezone | 18.4 | — | — | — | — | — | 95 | 94 | 85 | 95 | 94 | — |
| | Pyroxasulfone | 90 | | | | | | | | | | | |
| 8 | Topramezone | 18.4 | — | 90 | — | — | — | — | — | — | — | — | — |
| | Topramezone | 18.4 | — | 93 | — | — | — | — | — | — | — | — | — |
| | Pyroxasulfone | 90 | | | | | | | | | | | |
| 9 | Topramezone | 18.4 | — | — | — | — | — | — | — | — | 93 | — | 90 |
| | Topramezone | 18.4 | — | — | — | — | — | — | — | — | 98 | — | 93 |
| | Pyroxasulfone | 90 | | | | | | | | | | | |

This study shows that herbicidal mixtures of the present invention are effective against Fall Panicum, Waterhemp, Common Ragweed, Giant foxtail, Foxtail, Palmer Amaranth, Giant Ragweed, Broadleaf signalgrass, Yellow Nutsedge, Barnyardgrass, and Velvetleaf species.

In these studies, no corn phytotoxicity was observed.

1. An agricultural composition comprising a pigment synthesis inhibitor herbicide selected from the group consisting of a pyridazinone, isoxazolidinone, triketone, and isoxazole, or an agriculturally acceptable salt thereof, and pyroxasulfone in a ratio of from about 1:0.3 to about 1:150.

2. The composition of claim 1 wherein the pigment synthesis inhibitor is a pyridazinone.

3. The composition of claim 2 wherein the pyridazinone is norflurazon.

4. The composition of claim 1 wherein the pigment synthesis inhibitor is an isoxazolidinone.

5. The composition of claim 1 wherein the pigment synthesis inhibitor is a triketone.

6. The composition of claim 5 wherein the triketone is mesotrione.

7. The composition of claim 5 wherein the triketone is topramezone.

8. The composition of claim 1 wherein the pigment synthesis inhibitor is an isoxazole.

9. The composition of claim 1 wherein the ratio of the pigment synthesis inhibitor herbicide to pyroxasulfone is from about 1:0.6 to about 1:110.

10. The composition of claim 1 wherein the ratio of the pigment synthesis inhibitor herbicide to pyroxasulfone is from about 1:0.7 to about 1:20.

11. The composition of claim 1 further comprising atrazine.

12. A method of increasing the activity of a pigment synthesis inhibitor herbicide comprising applying an agricultural composition comprising a pigment synthesis inhibitor herbicide selected from the group consisting of a pyridazinone, isoxazolidinone, triketone, and isoxazole, or a salt thereof, and pyroxasulfone in a ratio of from about 1:0.3 to about 1:150 to an area in need of weed control.

13. The method of claim 12 wherein the pyroxasulfone is applied at a rate of from about 50 to about 150 grams per hectare.

14. The method of claim 12 wherein the pigment synthesis inhibitor herbicide is applied at a rate of from about 1 to about 150 grams per hectare.

15. The method of claim 12 wherein the weed controlled is selected from the group consisting of Waterhemp (Amaranthus tuberculatus), Horseweed (Conyza Canadensis), Ivyleaf Morningglory (Ipomoea hederacea), Pitted Morningglory (Ipomoea lacunose), Common Ragweed (Ambrosia artemisiifolia), Giant Ragweed (Ambrosia trifida), Large Crabgrass (Digitaria sanguinalis), Palmer Amaranth (Amaranthus palmeri), Broadleaf Signalgrass (Brachiaria platyhylla), Common Barnyardgrass (Echinochloa crus-galli), Yellow Nutsedge (Cyperus esculentus), Eclipta (Eclipta prostrate), Lamb's quarters (Chenopodium), Velvetleaf (Ablation theophrasti), Foxtail (Alopecurus species), Giant Foxtail (Setaria faberi) and annual grasses.

16. The method of claim 15 wherein the weed controlled is Waterhemp.

17. The method of claim 15 wherein the weed controlled is Ivyleaf Morningglory.

18. The method of claim 15 wherein the weed controlled is Yellow Nutsedge.

19. The method of claim 15 wherein the weed controlled is Giant Foxtail.

20. The method of claim 12 wherein the pigment synthesis inhibitor herbicide, or agriculturally acceptable salt thereof, and pyroxasulfone are applied concurrently or sequentially to the area in need of weed control.
